(19) United States
(12) Patent Application Publication
(10) Pub. No.: US 2025/0360933 A1
(43) Pub. Date: Nov. 27, 2025

(54) Maintenance System And Maintenance Method For An Indirect Vision System Of A Vehicle

(71) Applicant: MEKRA Lang GmbH & Co. KG, Ergersheim (DE)

(72) Inventor: Marc-André Vogelgesang, Cadolzburg (DE)

(73) Assignee: MEKRA Lang GmbH & Co. KG, Ergersheim (DE)

(21) Appl. No.: 19/184,319

(22) Filed: Apr. 21, 2025

(30) Foreign Application Priority Data
May 22, 2024 (DE) 102024114262.6

(51) Int. Cl. B60W 50/02; B60W 50/14

(52) U.S. Cl. CPC B60W 50/0205; B60W 50/14; B60W 2050/021; B60W 2050/0215; B60W 2050/146; B60W 2556/45

(57) ABSTRACT

A maintenance system for an indirect vision system of a vehicle. The indirect vision system has an optical sensor unit for acquiring image data of the environment of the vehicle, a processing unit for processing the image data acquired by the optical sensor unit, and a display unit, on which the image data processed by the processing unit is displayed. One or more of the optical sensor unit, processing unit and display unit has at least one subcomponent. A receiving unit is provided for receiving data, and an evaluation unit which, based on the data received by the receiving unit, generates a maintenance signal which indicates how long and/or whether the subcomponent, optical sensor unit, processing unit and reproduction unit, and/or the entire indirect vision system is still usable.

### BACKGROUND OF THE INVENTION

### 1. Field of the Invention

The present invention relates to a maintenance system for an indirect vision system of a vehicle and a method for maintaining such an indirect vision system.

With respect to vehicles, especially commercial vehicles such as trucks, there are areas around the vehicle that cannot be seen directly from a driver's position. In the case of a truck, such areas around the vehicle are, for example, the rear area or areas to the side of the vehicle. For enabling a driver to always see other road users or obstacles located in these areas, indirect vision devices are provided on the vehicle, such as mirror-based systems or camera-based systems, so-called camera monitor systems.

### 2. Description of the Related Art

Camera monitor systems for motor vehicles are known which contain a capturing unit, a calculation unit and a display unit. The capturing unit, for example a camera, is used to capture an area around a vehicle and, after processing by the calculation unit, if necessary, the captured image is displayed on the display unit in the driver's compartment of the vehicle for the driver to see. Such indirect vision systems are subject to legal regulations and, as they generally replace conventional mirrors, must be particularly fail-safe. To ensure such fail-safe operation, the entire system has so far been removed and replaced in the event of a failure of the indirect vision system, although usually only a sub-component of the indirect vision system, such as a capturing unit, is defective. Furthermore, the removed parts are usually scrapped and not recycled, as their wear and tear or the remaining service life specified by the manufacturer of the subcomponent cannot be determined with sufficient certainty.

Furthermore, in the event of a complaint, it is not possible to determine which components of the indirect vision system can be reused or do not need to be replaced. Therefore, in the event of a complaint, the entire system is usually removed and replaced, which is not sustainable.

In addition, it is desirable to achieve the highest possible reliability and, if possible, to provide information before the service life is reached if individual components of the vision system need to be replaced, as they are about to reach their predicted service life and there is therefore a risk that the entire vision system will soon fail.

### SUMMARY OF THE INVENTION

An object of the present invention is to solve the above problem and to improve sustainability in the event of a complaint or a defect of the indirect vision system by removing only individual components of the indirect vision system or by re-installing removed parts of the indirect vision system in other indirect vision systems. However, for this it must be determined how long and whether the individual components of the indirect vision system can still be used.

The above object is solved by a maintenance system according to claim 1 and a method for maintaining an indirect vision system according to claim 15. Advantageous further developments of the invention are given in the dependent claims.

The maintenance system for an indirect vision system of a vehicle according to the present invention comprises the indirect vision system comprising at least one optical sensor unit for acquiring image data of the environment of the vehicle, at least one processing unit for processing the image data acquired by the optical sensor unit, and at least one display unit (output unit) on which the image data processed by the processing unit is displayed (output). The image data displayed by the display unit can also be displayed on the display unit without prior processing by the processing unit. According to the present invention, the processing unit may be a separate unit of the indirect vision system, or may be part of the at least one optical sensor unit and/or of the at least one display unit, so that the indirect visual system can be formed more compact.

The maintenance system according to the present invention may further comprise a receiving unit that receives data and transmits it to an evaluation unit that generates a maintenance signal based on the received data. According to the invention, the receiving unit may be part of the evaluation unit, the display unit, and/or the optical sensor unit, and/or may be designed as a separate component. This maintenance signal indicates how long and/or whether subcomponents of the optical sensor unit, the processing unit and/or the playback unit can still be used. The maintenance signal is therefore an indicator of the wear and tear of the subcomponents. The maintenance signal can also indicate how long and/or whether the optical sensor unit, the processing unit and/or the playback unit can still be used. The maintenance signal can also indicate how long and/or whether the entire indirect vision system can still be used. This makes it possible to determine whether the optical sensor unit, the processing unit and/or the display unit or their subcomponents can still be used, i.e. whether they can be reinstalled in another indirect vision system, for example. The maintenance signal can also be used to determine the extent to which the individual units (the optical sensor unit, the processing unit and the display unit) of the indirect vision system and/or their subcomponents are worn out. By using the maintenance signal, it is therefore possible to determine whether individual subcomponents can be reused, whether an entire unit (optical sensor unit, processing unit, display unit) can be reused, or whether the entire indirect vision system must be scrapped, for example.

According to the invention, the data received by the receiving unit is acquired by at least one vehicle sensor. These are vehicle data which are relevant for the service life of the vehicle, the at least one subcomponent and/or at least one of the at least one optical sensor unit, the at least one processing unit and the at least one display unit. Data relevant to the service life of the vehicle or of the individual units and their subcomponents of the indirect vision system can also be provided by a control unit of the vehicle, which supplies corresponding information about the vehicle (vehicle data). In this case, the control unit itself can be the vehicle sensor or may be a separate component. Such vehicle-relevant data provides, for example, information about kilometers driven by the vehicle, kilometers driven by the vehicle during operation of a respective subcomponent, operating time of the vehicle, operating time of a respective subcomponent during operation of the vehicle and/or errors that have occurred in vehicle components. Such faults occurring in vehicle components can, for example, be detected by means of internal signals, such as voltage values, voltage jumps, voltage peaks, switching cycles, etc. acquired by sensors. According to the invention, the data received by the receiving unit can be internal data of the indirect vision system, such as voltage peaks, switching cycles, etc. that have occurred in the indirect system, and/or external signals.

In addition, or as an alternative to the above-mentioned vehicle sensor, the maintenance system according to the invention can have at least one further sensor that sends environmental data to the receiving unit, which data is independent of the vehicle and depends on external environmental factors. Such environmental data contains information about, for example, temperature, humidity, air pressure, UV exposure, dust, fine dust (particulate matter) and/or mechanical loads to which a unit of the indirect vision system or its subcomponent or the entire indirect vision system is exposed.

According to the present invention, the at least one further sensor, which determines environmental data that is independent of the vehicle and depends on environmental factors, may be included in the at least one optical sensor unit, at least one processing unit and/or at least one display unit and/or in at least one sub-component of these units. In this way, it is possible to measure the above-mentioned environmental factors directly at the units or their subcomponents in order to predict their expected service life.

Alternatively, the at least one additional sensor can also be attached to the vehicle as a separate component (part) and transmit vehicle-independent environmental data to the receiving unit of the maintenance system wirelessly or by wire.

According to the present invention, the evaluation unit of the maintenance system may further comprise a processing unit which subjects at least a portion of the vehicle data and/or environmental data received by the receiving unit from the at least one vehicle sensor and/or the at least one further sensor to a calculation function to generate the maintenance signal based on the calculated function value. The underlying calculation function has at least part of the received vehicle data and/or environmental data as function parameters. According to the invention, the calculation function can be designed as a calculation matrix whose dimension is given by the number of environmental factors that have a common relationship to one another. In this way, it is possible to assign more importance to individual data (vehicle data and/or environmental data) that are functionally relevant for individual units or their subcomponents of the indirect vision system than to other data, while simultaneously considering several different environmental data (environmental factors). The data that is assigned more importance has a greater effect on the length of the service life. Different values of the environmental factors are an indicator for the wear of a corresponding component.

Subcomponents of the optical sensor unit that can be subject to monitoring are, for example, the camera housing, the camera wing with carrier structure, an optical image sensor (on a circuit board), a processing board, a circuit board with power supply unit, voltage regulator, possibly memory modules, processors, resistors, transmission chips, etc., an optical lens system, a lens unit and seals.

Subcomponents of the display unit that may be subject to monitoring are, for example, a monitor with circuit board with voltage regulator, power supply unit, memory modules, processors, resistors, etc., a monitor holder for mechanically fixing the monitor to the vehicle, seals, housing and the like. Subcomponents of the processing unit that may be subject to monitoring are, for example, one or more circuit boards with power supply unit, voltage regulator, FPGA or other processors, microcontrollers, memory modules, resistors, level converters, transmission chips, CAN controllers, etc. The above lists of subcomponents of the optical sensor unit, the display unit and the processing unit are merely examples and are not final.

By using the above calculation function (calculation matrix), it is possible to assign more priority to individual data over other data. Individual data can have a different influence on different components, or the data can have a mutually combined influence. For example, the information on humidity (air moisture) and air temperature, which are measured in the optical sensor unit, is assigned more priority than, for example, air pressure or UV exposure of the optical sensor unit, as precipitated water causes problems in the event of temperature changes or cold surfaces, especially for the optical image sensor of the optical unit. Precipitation, such as rain, snow, ice and hail, can lead to corrosion damage, which particularly affects subcomponents of the optical sensor unit, such as the image sensor, electronic components, circuit boards, solder joints and electronically conductive components and parts in general. Humidity of air is problematic for the optical sensor unit, as condensed water poses problems in the event of temperature changes or cold surfaces. Dust in the optical sensor unit leads to problems that affect subcomponents such as seals, the lens surface, the folding mechanism, latching mechanism of the optical sensor unit with a camera wing on the outside of a vehicle. According to the present invention, depending on a specific subcomponent, a corresponding calculation function (calculation matrix) is used to determine the maintenance signal for this subcomponent, which has corresponding environmental data that is relevant or particularly relevant for this subcomponent as function parameters or matrix entries. The matrix entries in the calculation matrix represent a measure of the reduction in service life. As mentioned above, the calculation function or calculation matrix prioritizes certain vehicle data and/or certain environmental data (environmental factors), which are more relevant for the wear of a corresponding subcomponent, higher than other data when calculating or determining the maintenance signal. For different subcomponents, for the optical sensor unit, the processing unit and/or the display unit different calculation functions or calculation matrices can be used, which reflect the different influences of the vehicle data and/or the environmental data on the respective subcomponents or units.

According to the present invention, several maintenance signals can be calculated and used. The maintenance signals can be combined with each other, with a resulting maintenance signal (overall maintenance signal) indicating how long at least one subcomponent, at least one of the at least one optical sensor unit, the at least one processing unit and the at least one display unit, and/or the entire indirect vision system is still usable. By combining several maintenance signals, it is possible to predict the service life of the entire indirect vision system, for example, more reliably, because the expected service lives of the individual units (optical sensor unit, processing unit, display unit) and their subcomponents are considered.

According to the present invention, the evaluation unit may comprise a counter and a comparison unit, wherein the data received from the receiving unit and/or calculated data which have been subjected to the calculation function or calculation matrix are compared with a predetermined threshold value, and the counter increases (increments) when the threshold value increases (increments) when the threshold value is exceeded. For example, a temperature counter can increase each time when a predetermined temperature of 30 degrees is exceeded. The count value thus indicates how often a unit or subcomponent of the indirect vision system has been exposed to high temperature, which in turn allows conclusions to be drawn about the expected service life of the corresponding unit or subcomponent of the indirect vision system. The maintenance signal output by the evaluation unit, which is based on the value of the counter, thus indicates how often, for example, a critical temperature has been exceeded. The critical temperature (the threshold value) can, for example, be specified by the manufacturer of the unit or subcomponent of the indirect vision system, or can be determined empirically and change over time. The threshold value can, for example, be adjusted via a software update. Alternatively, according to the invention, the maintenance signal can also be determined based on sensor values that are stored over a predefined time interval, for example, wherein an average value is formed over all stored sensor values and the average value and the average value is compared with the predetermined threshold value.

According to the present invention, the evaluation unit can send the generated maintenance signal to the display unit, to an external diagnostic device and/or to a cloud. According to the invention, the evaluation unit itself can be provided in a vehicle, the external diagnostic device and/or the cloud. This makes it possible to display the expected service life of individual subcomponents, individual units of the indirect vision system or the entire indirect vision system to the driver of the vehicle directly on the display unit located in the vehicle interior, so that the corresponding subcomponent, the corresponding unit and/or the entire indirect vision system can be replaced before a failure occurs.

According to the present invention, the maintenance system may also comprise an action recommendation unit which receives the maintenance signal from the evaluation unit and generates an action signal based on the value of the counter for transmission to the at least one display unit, diagnostic device and/or cloud. By such an action signal it is possible to directly indicate to a user how to handle individual subcomponents or units of the indirect vision system or to directly indicate, for example in text form, whether and which components need to be replaced or can continue to be used or how long they can still be used. By outputting the maintenance signal and/or the action signal to an external diagnostic device, it can be determined in a workshop, for example, whether individual subcomponents or the entire indirect vision system need to be replaced or can continue to be used. By outputting the maintenance signal to the cloud, it is possible to analyze the units and their subcomponents of the indirect vision system or the entire indirect vision system regarding an expected service life, independent of a location.

According to the present invention, the information contained in the maintenance signal can be stored, either in a central memory of the maintenance system and/or in internal memories located in the subcomponents, the individual units of the indirect vision system and/or in the entire indirect vision system. In this way, it is possible to read the information contained in the maintenance signal directly from individual subcomponents or units of the indirect vision system for determining their expected service life and for deciding whether replacement is necessary or continued use (e.g. in another system) is possible.

According to the present invention, the receiving unit and/or the evaluation unit of the maintenance system can also be part of the indirect vision system. In this way, the maintenance signal or an action signal can be generated and evaluated directly in the indirect vision system.

According to a method according to the invention for generating a maintenance signal for an indirect vision system of a vehicle comprising at least one optical sensor unit, at least one processing unit and/or at least one display unit, the following steps are performed: Receiving data and generating a maintenance signal based on the received data, which indicates how long and whether at least one subcomponent of the at least one optical sensor unit, the at least one processing unit and/or the at least one display unit, and/or the entire indirect vision system is still usable.

According to the method according to the invention, the received data may comprise vehicle data detected by at least one vehicle sensor or supplied by a control unit of the vehicle, which data is relevant for the lifetime of the vehicle, the at least one subcomponent, the at least one optical sensor unit, the at least one processing unit and the at least one display unit, and/or the indirect vision system. The received data may additionally or alternatively comprise environmental data which is received from at least one further sensor and which is independent of the vehicle and dependent on external environmental factors.

According to the method according to the invention, the vehicle data can comprise information about kilometers driven by the vehicle, kilometers driven by the vehicle during operation of the at least one subcomponent, the at least one of the at least one optical sensor unit, the processing unit and the display unit and/or the entire indirect vision system, operating time of the vehicle, operating time of the at least one of the optical sensor unit, the processing unit and the display unit and/or the entire indirect vision system during operation of the vehicle, and/or faults that have occurred in vehicle components.

According to the method according to the invention, the external environmental data may include information about temperature, air humidity, air pressure, UV exposure, dust, particulate matter, and/or mechanical stresses to which the at least one subcomponent, the at least one of the at least one optical sensor unit, the at least one processing unit and the at least one display unit, and/or the indirect vision system is exposed.

According to the method according to the invention, a function value can be calculated by means of a calculation function or calculation matrix which comprises at least a part of the received vehicle data and/or the environmental data as parameters or matrix entries, wherein the maintenance signal is generated based on the calculated function value or matrix entry.

According to the method according to the invention, a plurality of maintenance signals can be combined and the resulting maintenance signal can be used to indicate how long the at least one subcomponent, the at least one of the at least one optical sensor unit, the at least one processing unit and the at least one display unit, and/or the entire indirect vision system is still usable.

According to the method according to the invention, the received data and/or calculated data can be compared with a threshold value, and a counter can be incremented if the threshold value is exceeded (each time the threshold value is exceeded).

According to the method according to the invention, the maintenance signal can be generated based on the value of the counter and output to the at least one display unit, to a diagnostic device and/or to a cloud.

The method according to the invention can further generate an action signal based on the value of the counter and output it to the at least one display unit, the diagnostic device and/or the cloud.

According to the method according to the invention, furthermore, the data received from the sensors and/or the control unit, the calculated data, threshold values and/or maintenance signals can be stored in the at least one subcomponent, the at least one of the at least one optical sensor unit, the at least one processing unit and the at least one display unit and/or the indirect vision system.

The method according to the invention can be used by the above-mentioned maintenance system according to the invention.

### Aspects of the Invention

According to a first aspect of the invention, a maintenance system is provided for an indirect vision system (2) of a vehicle (1), comprising
the indirect vision system (2) having
   at least one optical sensor unit (3) for acquiring image data of the environment of the vehicle,
   at least one processing unit (9) for processing the image data acquired by the optical sensor unit (3), and
   at least one display unit (4) on which the image data processed by the processing unit (9) are displayed,
wherein at least one of the at least one optical sensor unit (3), the at least one processing unit (9) and the at least one display unit (4) includes at least one subcomponent (16, 17, 18, 19, 23, 24, 26);
a receiving unit (6) for receiving data; and
an evaluation unit (10) which, based on the data received by the receiving unit (6) unit (6), generates a maintenance signal indicating how long and/or whether the at least one subcomponent (16, 17, 18, 19, 23, 24, 26), the at least one of the at least one optical sensor unit (3), the at least one processing unit (9) and the at least one display unit (4), and/or the entire indirect vision system is still usable.
   According to a second aspect of the invention, the maintenance system of aspect one further comprises
at least one vehicle sensor (7) which transmits vehicle data to the receiving unit (6) which data is relevant for the service life of the vehicle (1), the at least one subcomponent (16, 17, 18, 19, 23, 24, 26) and/or the at least one of the at least one optical sensor unit (3), the at least one processing unit (9) and the at least one display unit (4), and/or
at least one additional sensor (8) which transmits environmental data to the receiving unit (6), which data is independent of the vehicle and depends on environmental factors.
   According to a third aspect of the invention, the maintenance system according to aspect two is further defined where the at least one optical sensor unit (3), the at least one processing unit (9), the at least one display unit (4) and/or the at least one subcomponent (16, 17, 18, 19, 23, 24, 26) comprises the at least one additional sensor (8).
   According to a fourth aspect of the invention, the maintenance system according to aspect two or three, is further defined where the vehicle data includes information about kilometers driven by the vehicle, kilometers driven by the vehicle during operation of the at least one subcomponent (16, 17, 18, 19, 23, 24, 26), the at least one of the optical sensor unit (3), the processing unit (9) and the display unit (4), and/or the entire indirect vision system, operating time of the vehicle, operating time of the at least one subcomponent (16, 17, 18, 19, 23, 24, 26), of the at least one of the optical sensor unit (3), the processing unit (9) and the display unit (4) and/or the entire indirect vision system during operation of the vehicle, and/or errors occurred in vehicle components.
   According to a fifth aspect. the maintenance system according to aspect two or three is further defined wherein the environmental data comprises information about temperature, air humidity, air pressure, UV exposure, dust, fine dust (particular matter), and/or mechanical load, to which the at least one subcomponent (16, 17, 18, 19, 23, 24, 26), the at least one of the optical sensor unit (3), the processing unit (9) and the display unit (4) and/or the entire indirect vision system, is subjected to.
   According to a sixth aspect, the maintenance system according to one of the preceding aspects is further defined where the evaluation unit (10) further comprises a calculation unit (32) which subjects at least a part of the vehicle data and/or environmental data received from the receiving unit (6), the at least one vehicle sensor (7) and/or the at least one additional sensor (8) to a calculation function or calculation matrix and generates the maintenance signal based on the calculated value, wherein the calculation function or the calculation matrix comprises at least part of the received vehicle data and/or environmental data as a function parameter or matrix element.
   According to a seventh aspect. the maintenance system according to any one of the preceding aspects is further defined where a plurality of maintenance signals is used and calculated, and the resulting maintenance signal indicates how long the at least one sub-component (16, 17, 18, 19, 23, 24, 26), the at least one of the at least one optical sensor unit (3), the at least one processing unit (9) and the at least one display unit (4), and/or the entire indirect vision system is still usable.
   According to an eight aspect the maintenance system according to one of the preceding aspects is further defined where the evaluation unit (10) comprises a counter (30) and a comparison unit (29), wherein the data and/or calculated/processed data received by the receiving unit (6) is compared with a threshold value and the counter (30) increments when the threshold value is exceeded.
   According to a ninth aspect. the maintenance system according to aspect seven is further defined where the evaluation unit (10) generates the maintenance signal based on the value of the counter (30).
   According to a tenth aspect the maintenance system according to aspect nine further comprises an action recommendation unit (12) which receives the maintenance signal from the evaluation unit (10), generates an action signal based on the value of the counter (30) and transmits it to the at least one display unit (4), diagnostic device (11) and/or to a cloud (13) for output.
   According to an eleventh aspect, the maintenance system according to any one of the preceding aspects, is further defined where the maintenance signal generated by the evaluation unit (10) is transmitted to the at least one display unit (4), diagnostic device (11) and/or cloud (13) for output.
   According to a twelfth aspect, the maintenance system according to any one of the preceding aspects, further comprising a memory (20) storing the data received from the receiving unit (6), the data calculated by the calculation unit (32), the maintenance signal, the action signal and/or the threshold value.
   According to a thirteenth aspect, the maintenance system according to any one of the preceding aspects, is further defined where
the at least one subcomponent (16, 17, 18, 19, 23, 24, 26), the at least one of the at least one optical sensor unit (3), the at least one processing unit (9) and the at least one display unit (4), and/or the entire indirect vision system comprises a memory (20) in which the information contained in the maintenance signal is stored, which indicates how long and/or whether the subcomponent (16, 17, 18, 19, 23, 24, 26), the at least one of the at least one optical sensor unit (3), the at least one processing unit (9) and the at least one display unit (4), and/or the entire indirect vision system is still usable.
   According to a fourteenth aspect, the maintenance system according to any one of the preceding aspects is further defined where the receiving unit (6) and/or the evaluation unit (10) are part of the indirect vision system (2).
   According to a fifteenth aspect, a method is provided for generating a maintenance signal for an indirect vision system of a vehicle, comprising at least one optical sensor unit (3), at least one processing unit (9) and/or at least one display unit (4), comprising the steps of
receiving data; and
generating a maintenance signal based on the received data which signal indicates how long at least one subcomponent (16, 17, 18, 19, 23, 24, 26) of the at least one optical sensor unit (3), the at least one processing unit (9) and/or the at least one display unit (4), and/or the at least one of the at least one optical sensor unit (3), the at least one processing unit (9) and the at least one display unit (4), and/or the entire indirect vision system is still usable.
   According to a sixteenth aspect, the method according to aspect fifteen is further defined where
the received data comprises vehicle data which is detected by at least one vehicle sensor (7), and which is relevant for the lifetime of the vehicle (1), the at least one subcomponent (16, 17, 18, 19, 23, 24, 26), the at least one of the at least one optical sensor unit (3), the at least one processing unit (9) and the at least one display unit (4), and/or the indirect vision system (2), and/or
the received data comprises environmental data obtained from at least one additional sensor (8), which data is independent of the vehicle and depend on environmental factors.
   According to a seventeenth aspect, the method according to aspect sixteen is further defined wherein
the vehicle data comprises information about kilometers driven by the vehicle, kilometers driven by the vehicle during operation of the at least one subcomponent (16, 17, 18, 19, 23, 24, 26), the at least one of the optical sensor unit (3), the processing unit (9) and the display unit (4), and/or the entire indirect vision system, operating time of the vehicle, operating time of the at least one subcomponent (16, 17, 18, 19, 23, 24, 26), the at least one of the optical sensor unit (3), the processing unit (9) and the display unit (4) and/or the entire indirect vision system, during operation of the vehicle and/or errors occurred in vehicle components.
   According to an eighteenth aspect, the method according to aspect sixteen is further defined where
the environmental data comprises information about temperature, air humidity, air pressure UV exposure, dust, particulate matter, and/or mechanical stress (load), to which the at least one subcomponent (16, 17, 18, 19, 23, 24, 26), at least one of the at least one optical sensor unit (3), the at least one processing unit (9) and the at least one display unit (4), and/or the indirect vision system is exposed.
   According to a nineteenth aspect, the method according to aspects fifteen through eighteen further comprise
calculating a function value, wherein the calculation function comprises at least a part of the received vehicle data and/or the environmental data as parameters; and
generating the maintenance signal based on the function value.
   According to a twentieth aspect, the method according to any one of the preceding aspects, further comprise
combining a plurality of maintenance signals; and
using the resulting maintenance signal that indicates how long the at least one sub-component (16, 17, 18, 19, 23, 24, 26), at least one of the at least one optical sensor unit (3), the at least one processing unit (9) and the at least one display unit (4), and/or the entire indirect vision system can still be used.
   According to a twenty-first aspect, the method according to aspect nineteen or twenty, further comprise
comparing the received data and/or the calculated data with a threshold value; and
incrementing a counter (30) when the threshold value is exceeded.
   According to a twenty-second aspect, the method according to aspect twenty-one further comprises
generating the maintenance signal based on the value of the counter (30), and
outputting the maintenance signal to the at least one display unit (4), diagnostic device (11) and/or cloud (13).
   According to a twenty-third aspect, the method according to aspect twenty-one or twenty-two further comprise
generating an action signal based on the value of the counter, and
outputting the action signal to the at least one display unit (4), diagnostic device (11) and/or cloud (13).
   According to a twenty-fourth aspect, the method according to any one of aspects fifteen to twenty-three, further comprise
storing the received data, the calculated data, the threshold value and/or the maintenance signal in at least the subcomponent (16, 17, 18, 19, 23, 24, 26), at least one of the at least one optical sensor unit (3), the at least one processing unit (9) and the at least one reproducing unit (4), and/or in the indirect vision system.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Preferred embodiments of the invention are described below with reference to the accompanying figures.

FIG. 1 shows a plan view of a vehicle with an indirect vision system for which the maintenance system and maintenance method according to the invention can be used;

FIG. 2 shows schematic view of the essential components of the maintenance system according to the invention according to one embodiment;

FIG. 3 shows a schematic view of an optical sensor unit of the indirect vision system of FIG. 1;

FIG. 4 shows a schematic view of a processing unit of the indirect vision system of FIG. 1;

FIG. 5 shows a display unit of the indirect vision system of FIG. 1;

FIG. 6 shows an evaluation unit of the maintenance system according to the invention;

FIG. 7 shows a schematic representation of a calculation matrix used by the maintenance system and method according to the invention to determine the maintenance signal according to an embodiment of the invention;

FIG. 8 shows an action recommendation unit of the maintenance system according to the invention;

FIG. 9 shows a schematic flow chart of a method according to the invention with alternative embodiments; and

FIG. 10 a schematic flow chart of the method according to the invention according to an alternative embodiment.

### DETAILED DESCRIPTION OF THE PREFERRED EMBODIMENTS

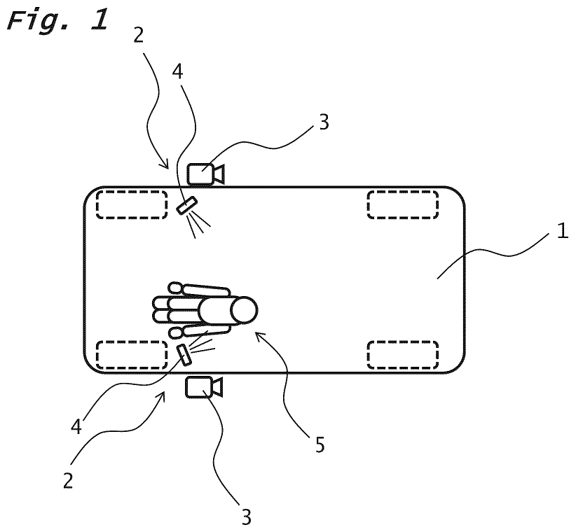

FIG. 1 shows a vehicle 1 on which an indirect vision system 2 is arranged, with camera wings arranged on the left and right sides of the vehicle 1. The indirect vision system 2 contains an optical sensor unit 3 and a display unit 4. Image data captured by the optical sensor unit 3 is displayed to a driver 5 of the vehicle 1 on the display unit 4.

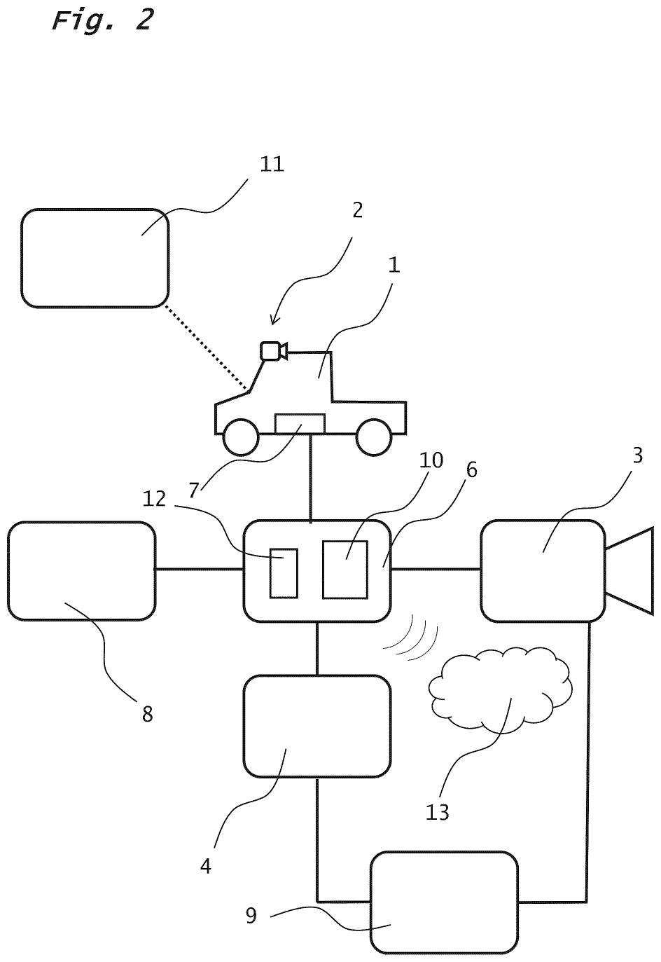

FIG. 2 shows components of a maintenance system according to a preferred embodiment of the invention. The maintenance system includes the indirect vision system 2 according to FIG. 1, a receiving unit 6 for receiving data from a vehicle sensor 7 and from an environmental sensor 8. The vehicle sensor 7 comprises one or more sensors present in the vehicle 1. The vehicle sensor 7 can also be a control unit of the vehicle 1, which transmits relevant data to the receiving unit 6 of the maintenance system. The at least one vehicle sensor 7 acquires vehicle data that is relevant for the service life of the vehicle 1 and for the service life of the indirect vision system 2, its optical sensor unit 3, display unit 4 and/or processing unit 9 and their subcomponents.

According to the preferred embodiment example, the maintenance system can be used for an indirect vision system 2, which comprises several optical sensor units 3, display units 4 and processing units 9. The processing unit 9 can be a separate component of the indirect vision system 2 or part of the optical sensor unit 3 and/or the display unit 4. The processing unit 9 is primarily used to process image data captured by the optical sensor unit 3 and to display it on the display unit 4. Alternatively, the captured image data can be displayed unprocessed on the display unit 4.

The data acquired by the vehicle sensor 7 relates to data relevant to the vehicle, such as kilometers driven by the vehicle, kilometers driven by the vehicle when the indirect vision system 2 or its units 3, 4, 9 and their subcomponents are in operation. The at least one further sensor 8 primarily acquires environmental data that is independent of the vehicle and depends on environmental factors. Such environmental data includes, for example, information on temperature, air humidity, air pressure, UV exposure, dust, fine dust (particular matter) and/or mechanical loads (stresses) of the indirect vision system 2 or its units 3, 4, 9 and their subcomponents.

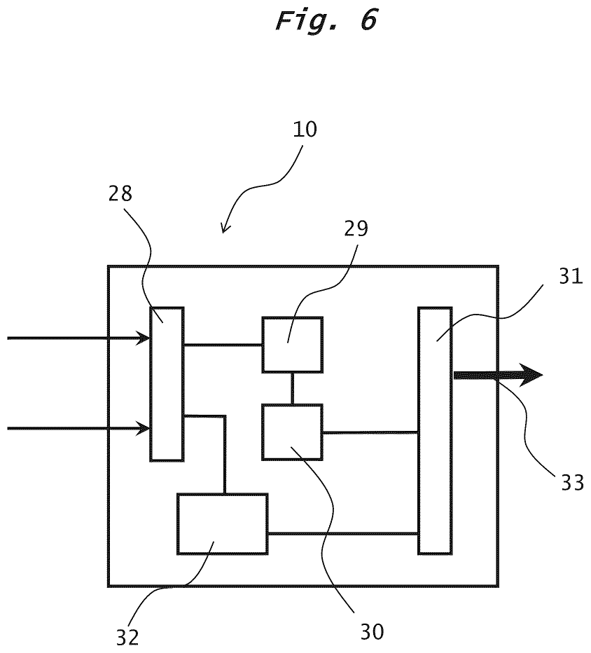

As shown in FIG. 2, the receiving unit 6 of the maintenance system according to the preferred embodiment comprises an evaluation unit 10, which is described in more detail below with reference to FIG. 6. The evaluation unit 10 generates a maintenance signal based on the data received from the vehicle sensor 7 and the additional sensor 8, which indicates how long the indirect vision system or its units 3, 4, 9 and their subcomponents can still be used. According to the preferred embodiment, the additional sensor 8 is provided in each of the optical sensor unit 3, the display unit 4 and the processing unit 9, but can alternatively also be provided as a separate component attached at any position on the vehicle 1.

FIG. 2 also shows an external diagnostic device 11 that can be connected to the vehicle 1 during a workshop visit, for example, in order to read out the maintenance signal generated by the evaluation unit 10 and display the remaining service life (wear) of the units of the indirect vision system 2 or its subcomponents and/or the entire indirect vision system 2 to a user of the diagnostic device 11.

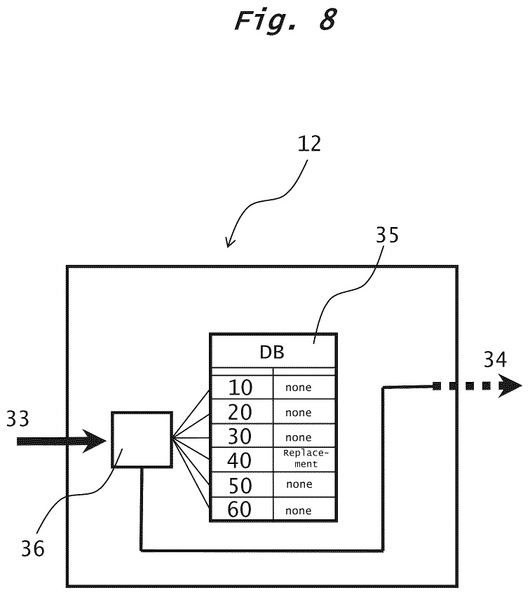

FIG. 2 also shows an action recommendation unit 12, which is described in more detail below with reference to FIG. 8 and outputs an action signal that can be received by the diagnostic device 11, the display unit 4 and/or the cloud. The action signal indicates to the user of the diagnostic device 11 specific actions, for example in text form, which the user must perform for example, to replace a subcomponent or a unit of the indirect vision system or the entire indirect vision system 2.

FIG. 2 also shows a schematically depicted cloud 13, to which, according to the preferred embodiment the generated maintenance signal and/or the action signal are sent, for further processing elsewhere. According to another embodiment all data from the vehicle sensor 7 and the other sensor 8 are also sent to the cloud 13. Data from the cloud 13 is also received by the receiving unit 6. Such data contains, for example, threshold values or the calculation matrix that is used to generate the maintenance signal, as described below. Similarly, environmental data, as described above, can also be sent from the cloud to the receiving unit 6. This data can be used in addition to or as an alternative to the data from the vehicle sensor 7 and the additional sensor 8 for generating the maintenance signal or the action signal.

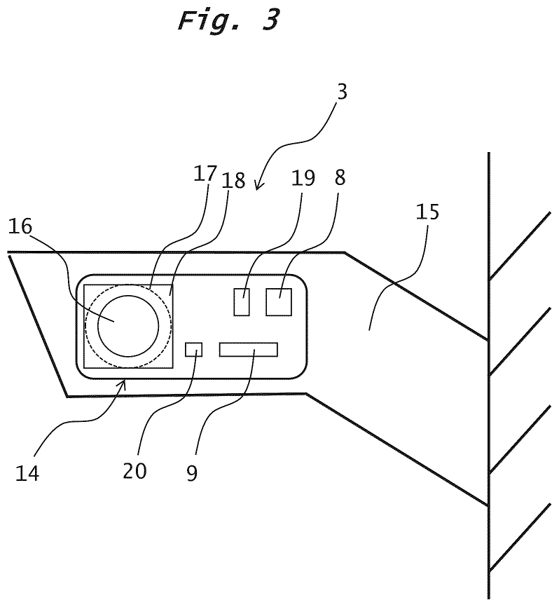

FIG. 3 shows the optical sensor unit 3 with exemplary subcomponents. AS exemplary subcomponents, FIG. 3 shows a camera housing 14, a camera wing 15, a lens system 16, a lens heater 17, an image sensor 16, a processing board 19 with, for example power supply unit, voltage regulator, memory modules, processors, resistors, transmission ICs and the like (not shown), and a seal 20. FIG. 3 also shows the processing unit 9, which processes image data captured by the image sensor 18 for display on the display unit 4 shown in FIG. 2. According to other embodiments, the processing unit 9 can be arranged outside the optical sensor unit 3, for example in the display unit 4.

FIG. 3 also shows the further sensor 8 of FIG. 2, which according to the present embodiment is arranged in the optical sensor unit 3 to acquire environmental data that is independent of the vehicle and dependent on environmental factors. The further sensor 8 arranged in the optical sensor unit3 detects, for example, the prevailing (current) temperature, humidity in the optical sensor unit 3 and/or other environmental data mentioned above. This data is output to the evaluation unit 10 and/or the action recommendation unit 12, for example to generate a maintenance signal or action signal for the sensor unit 3.

FIG. 3 also shows an internal memory 20 in the optical sensor unit 3. The internal memory 20 stores all relevant data according to the preferred embodiment example, such as environmental data detected by the additional sensor 8, image data processed by the processing unit 9, image data captured by the image sensor 18, maintenance signals generated by the evaluation unit 10 and/or action signals output by the action recommendation unit 12.

According to the preferred embodiment, the information stored in the internal memory 20 that comprises the maintenance information indicates the expected service life of the optical sensor unit 3 or of at least one of the subcomponents 16, 17, 18, 19, 20. The information stored in the internal memory 20 of the optical sensor unit 3 can, for example, according to the preferred embodiment example, be read out by the diagnostic device 11 shown in FIG. 2, be displayed on the display unit 4 and/or be sent to the cloud 13.

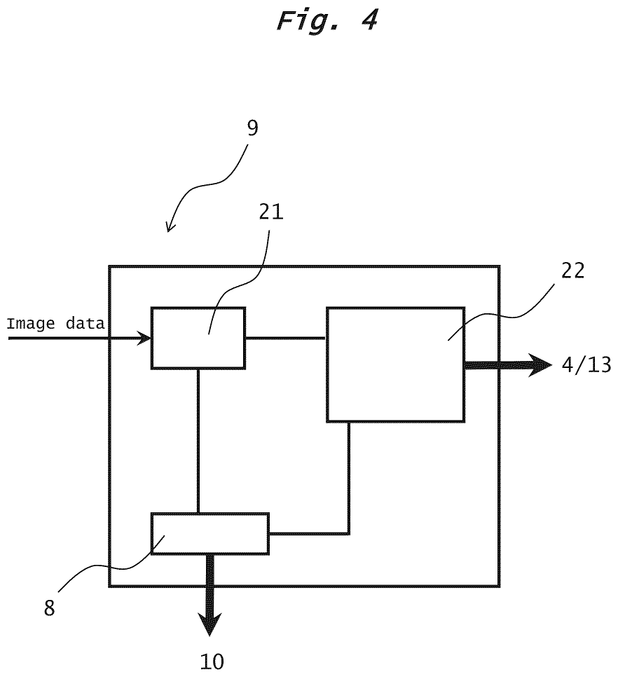

FIG. 4 schematically shows the processing unit 9 shown in FIG. 3. The processing unit 9 comprises a memory 21 in which, for example, image data captured by the image sensor 18 can be stored. FIG. 4 also shows a circuit board 22 which processes the image data temporarily stored in the memory 21 for output to the display unit 4. According to the preferred embodiment, the processing unit 9, as shown in FIG. 4, comprises the additional sensor 8 which can detect the above-mentioned environmental data, which are additionally stored in the memory 21, for example. The processing unit 9 is able to transmit the data acquired by the additional sensor 8 or the environmental data stored in the memory 21 for further evaluation to the evaluation unit 10 and/or the action recommendation unit 12 to generate a maintenance signal or action signal. The maintenance signal is indicative of the expected remaining service life of the processing unit 9. The maintenance signal and/or the action signal are stored in the memory 21 according to the embodiment example and can be read out by the diagnostic device 11, the display unit 4 and/or the cloud 13.

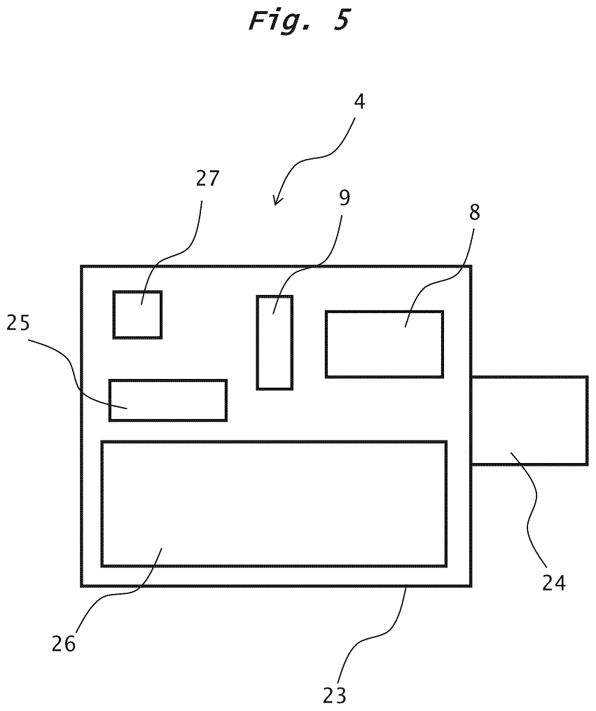

FIG. 5 shows a schematic view of the display unit 4 of the indirect vision system 2 of FIG. 1 according to an embodiment. As subcomponents of the display unit 4, FIG. 5 shows, for example, a housing 23, a circuit board 25 with power supply unit, voltage regulator, FPGA or other processors, microcontrollers, memory modules, resistors, level converters, transmission chips, CAN controllers, etc.

As shown in FIG. 5, the display unit 4 contains the additional sensor 8 to detect the above-mentioned environmental data. According to this embodiment, the processing unit 9 shown in FIG. 4 is included in the display unit 4, but can alternatively be provided as a separate component of the indirect vision system. FIG. 5 also shows a display area 26 and a memory 27. On the display area 26, the image data processed by the processing unit 9 is displayed to the driver 5 of the vehicle 1. In the memory 27, the environmental data acquired by the additional sensor 8 is stored and transmitted to the evaluation unit 10 or action recommendation unit 12 in a similar way as described with respect to the optical sensor unit 3, and/or is transmitted directly to the cloud 13 and/or a diagnostic device 11. The generated maintenance signal for the display unit 4 and/or the action signal are stored in the memory 27 according to the embodiment, and can be read out by the diagnostic device 11 and/or the cloud 13. According to the embodiment, the maintenance signal and/or the action signal are displayed on the display area 26 of the display unit 4.

FIG. 6 shows the evaluation unit 10 according to the preferred embodiment of the maintenance system. The evaluation unit 10 receives data at an input module 28 from a vehicle sensor 7 and/or the additional sensor 8. According to the preferred embodiment data is received from the additional sensors 8 of the optical sensor unit 3, the display unit 4 and/or the processing unit 9 as described above. As shown in FIG. 6, the evaluation unit 10 comprises a comparison unit 29 and a counter 30. The comparison unit 29 receives, for example, a temperature value from the input module 28 and compares this temperature value with a predetermined threshold value. If this predetermined threshold value is exceeded, in particular during a certain period of time, the counter 30 is increased according to the preferred embodiment example. If, for example, the threshold value is exceeded for a predetermined period of time, the counter can be increased by a predetermined value that depends on the predetermined duration. For example, if the threshold value is exceeded for 10 minutes, the counter can be incremented by one. If the threshold value is exceeded for further 10 minutes, for example, the counter can be incremented by one again, etc. Other dependencies between time duration and counter value incrementation are conceivable according to the invention and may also depend on the type of the environmental data.

Alternatively, an average over several temperature values obtained in a predetermined time interval can be determined and compared with the predetermined threshold value, in order to increment the counter by a predetermined value, if the threshold value is exceeded. The value of the counter 30 is output via an output module 31 of the evaluation unit 10. The above-mentioned threshold value is a value specified by the manufacturer of the indirect vision system, of a unit of the indirect vision system or of a sub-component thereof that is indicative of the expected total service life of the corresponding component.

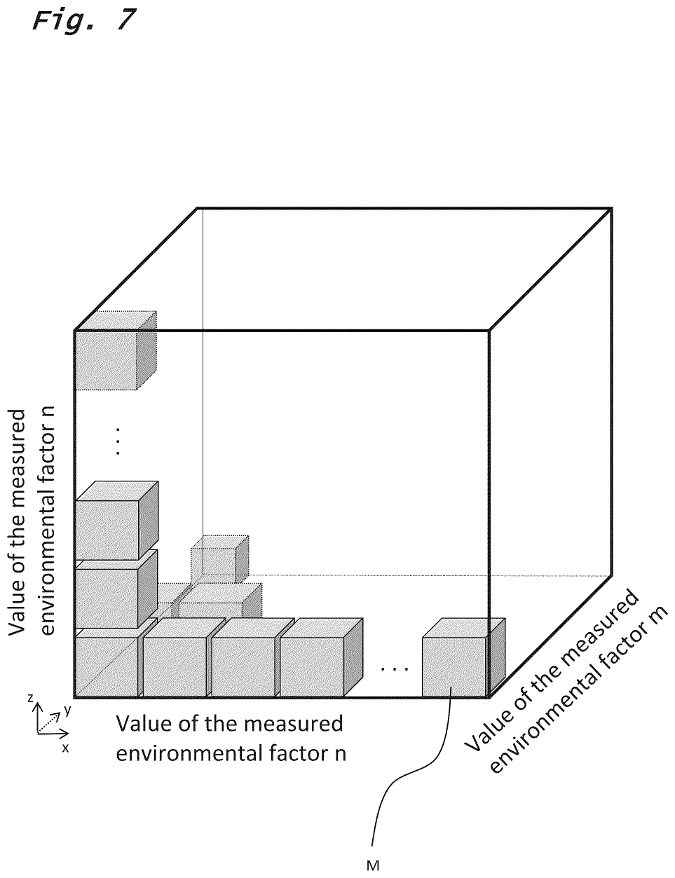

The evaluation unit 10 also comprises a calculation unit 32, which receives data (vehicle data, environmental data) from the input module 28 and subjects it to a predetermined calculation function or calculation matrix, which is described in more detail below with reference to FIG. 7. The evaluation unit 10 shown in FIG. 6 thus receives data from the vehicle sensor 7 and the additional sensors 8 and generates a maintenance signal 33 for the indirect vision system 2, its units 3, 4, 9 and/or its subcomponents. The maintenance signal 33 is output by the evaluation unit 10 via the output module 31. According to the preferred embodiment, the output is transmitted to the diagnostic device 11, the cloud 13, the display unit 4 and/or the action recommendation unit 12, as described with reference to FIG. 8.

FIG. 7 shows a calculation matrix according to an embodiment of the invention, by means of which the maintenance signal is determined, which indicates the remaining service life of the indirect vision system, one of its units and/or their subcomponents. According to the invention, the calculation matrix is stored in the maintenance system, the cloud and/or the external diagnostic device to calculate the influence of various environmental factors. Here, the dimension of the matrix corresponds to the number of related environmental factors. The entries of the matrix correspond to the influence on the service life of a component under consideration (component means the indirect vision system as a whole, at least one of its above-mentioned units and/or at least one of its subcomponents). By using the concrete measured value of the environmental factors at a specific time it is referred to a specific matrix entry, which is then used to calculate the remaining service life, or the entries are stored for different points in time and then the remaining service life of the components is then calculated from the matrix entries stored at different times. The multidimensional dependency of various environmental factors is mapped in this way.

At predetermined time intervals (e.g. every hour), for example, temperature (environmental factor k), humidity (environmental factor n) and UV exposure (environmental factor m) are measured in the camera via the additional sensors 8 implemented there. The measured values are referenced to a matrix element M. This matrix element M is then depending of the time interval or independently thereof stored in the system. The stored entries are then used to calculate the remaining service life of a component. Here high values of temperature and humidity, for example, have a more negative value than low values. A high temperature in combination with a very low humidity can result in a significantly lower reduction in the service life of a component than a medium temperature combined with high humidity. For the measurement, the humidity of the environment combined with a probability of leaks within the optical path that are relevant for the ingress of moisture can be used.

FIG. 8 schematically shows the action recommendation unit 12. According to the preferred embodiment of the invention, this unit receives the maintenance signal 33 from the evaluation unit 10 and outputs an action signal 34 to the display unit 4, the diagnostic device 11 and/or the cloud 13. According to the invention, the action recommendation unit 12 comprises a database 35 in which, for example, specific text-based instructions for an action are stored, which inform a user of the maintenance system about what needs to be done. The database according to the invention comprises, for example, a left-hand column in which all possible maintenance signals are stored, and a right-hand column in which the associated actions are stored. According to the preferred embodiment, the action recommendation unit 12 comprises a comparison module 36, which receives the maintenance signal 33, compares it with all the data in the left-hand column of the column of the database 35 and, in the event of a match or approximate match outputs the corresponding action instruction in the right-hand column as an action signal 34. Such an action instruction can be, for example: “Replace component”, “Remaining service life is 1 year”, ‘Component can be reused’, etc.

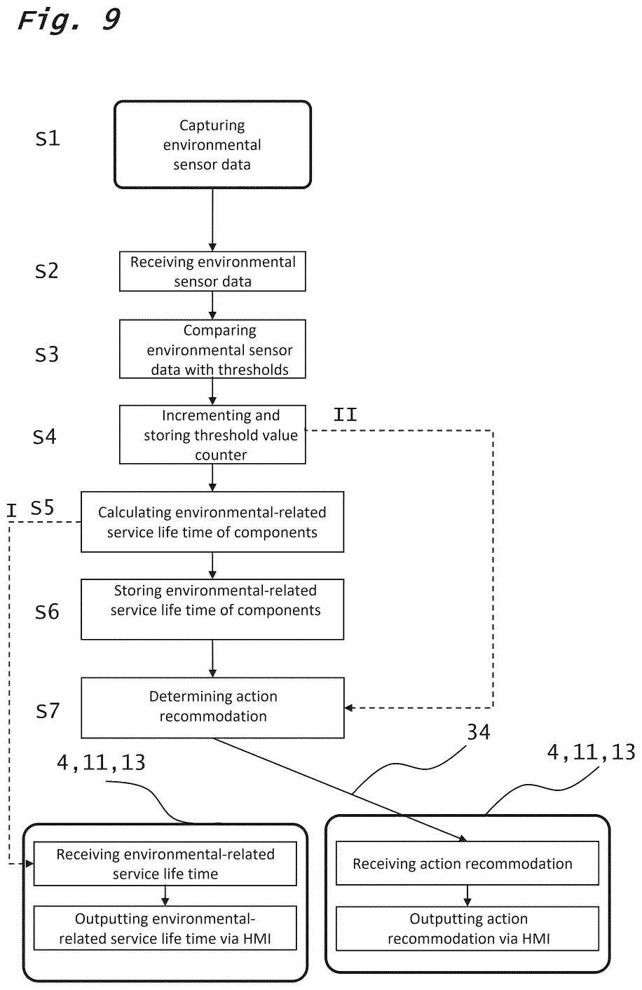

FIG. 9 shows a schematic flow chart of a method according to an embodiment of the invention. In step S1, according to this embodiment, environmental data is acquired by the additional sensor 8 and forwarded to the receiving unit 6. This transmits the data to the evaluation unit 10, which receives the data in step S2. In step S3, the data is compared with a threshold value by the comparison unit 29 of the evaluation unit 10, and in step S4, the counter 30 of the evaluation unit 10 is increased (incremented) by a predetermined value if a predetermined threshold value is exceeded. Preferably the predetermined threshold value must be exceeded for a predetermined period of time before the counter is increased or incremented. The predetermined value by which the counter is increased preferably depends on the predetermined time duration. In step S4, the current counter value is stored, and based on the counter value, the maintenance signal is generated in step S5, which indicates the environmental factor-related service life of the corresponding component to which the sensor 8 is associated. In step S6, the maintenance signal for the component is stored in the component itself and/or in an external memory.

In step S7, an action signal is generated based on the maintenance signal generated in step S5 and stored in step S6 and output to the display unit 4, the diagnostic device 11 and/or the cloud 13. As shown in FIG. 9, the action signal 34 is received by the display unit 4, the diagnostic device 11 and/or the cloud 13 and displayed to the user of the maintenance system via a human-machine interface HMI.

According to another embodiment (I) of the invention, the maintenance signal generated in step S5 can be output directly to the display unit 4, the diagnostic device 11 and/or the cloud 13. Since the maintenance signal in step S5 is based on the count value obtained in step S4 this count value is an indicator of the remaining service life. According to this embodiment (I), the user must interpret the maintenance signal himself without being shown a specific recommendation for an action. According to yet another embodiment example (II), as shown in FIG. 9, the counter value obtained in step S4 can be processed directly in step S7 in order to generate an action signal 34 in step S7. This action signal 34 can then be output to the display unit 4, the diagnostic device 11 and/or the cloud 13 in a similar way.

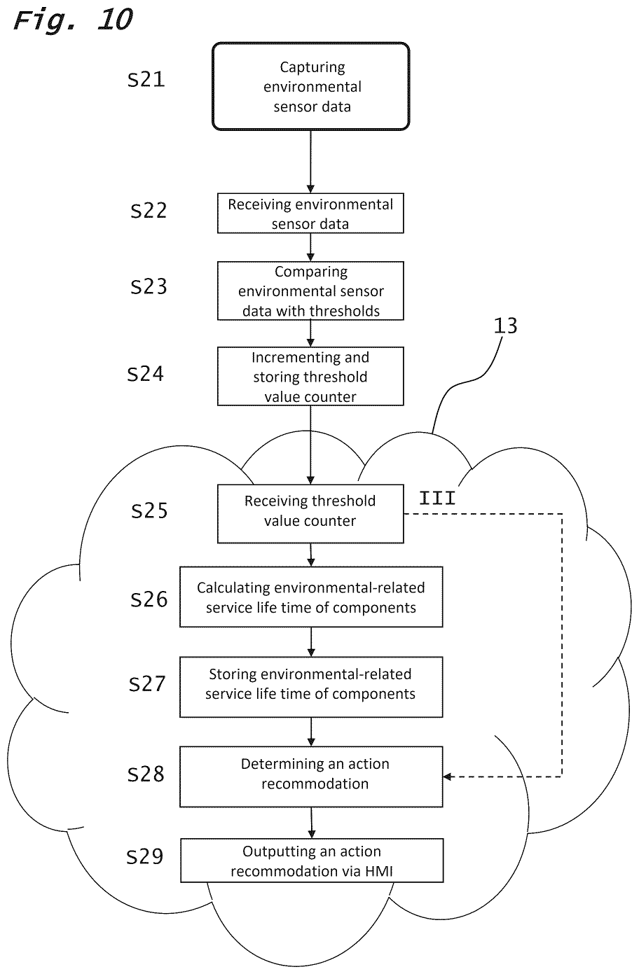

FIG. 10 shows a schematic flow chart of the method according to the invention in accordance with an alternative embodiment. Steps S21 to S24 in FIG. 10 correspond to steps S1 to S4 of FIG. 9 and are therefore not described repeatedly.

As shown in FIG. 10, the count value obtained in step S24 is transmitted to the cloud 13, where it is received in step S15. In step S26, the maintenance signal is generated based on the received count value within the cloud 13 and stored in step S27. Similar to FIG. 9, an action signal is generated in step S28 based on the maintenance signal stored in S27 and output to a human-machine interface in step S29. As shown in FIG. 10, according to this embodiment, steps S25 to S29 are carried out entirely within the cloud 13. Similar to the method according to FIG. 9, according to an alternative embodiment (III), an action signal can be generated in step S28 directly from the count value obtained from the cloud in step S25, without generating and storing a maintenance signal.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A maintenance system for an indirect vision system of a vehicle, the indirect vision system having
at least one optical sensor unit for acquiring image data of the environment of the vehicle,
at least one processing unit for processing the image data acquired by the optical sensor unit, and
at least one display unit on which the image data processed by the processing unit are displayed,
wherein at least one of the at least one optical sensor unit, the at least one processing unit and the at least one display unit includes at least one subcomponent;
wherein the maintenance system comprises:
a receiving unit for receiving data; and
an evaluation unit which, based on the data received by the receiving unit, generates a maintenance signal indicating how long and/or whether the at least one subcomponent, the at least one of the at least one optical sensor unit, the at least one processing unit and the at least one display unit, and/or the entire indirect vision system is still usable.

2. The maintenance system according to claim 1, further comprising
at least one vehicle sensor which transmits vehicle data to the receiving unit which data is relevant for the service life of the vehicle, the at least one subcomponent and/or the at least one of the at least one optical sensor unit, the at least one processing unit and the at least one display unit, and/or
at least one additional sensor which transmits environmental data to the receiving unit, which data is independent of the vehicle and depends on environmental factors.

3. The maintenance system according to claim 2, wherein the at least one optical sensor unit, the at least one processing unit, the at least one display unit and/or the at least one subcomponent comprises the at least one additional sensor.

4. The maintenance system according to claim 2, wherein the vehicle data includes information about kilometers driven by the vehicle, kilometers driven by the vehicle during operation of the at least one subcomponent, the at least one of the optical sensor unit, the processing unit and the display unit, and/or the entire indirect vision system, operating time of the vehicle, operating time of the at least one subcomponent, of the at least one of the optical sensor unit, the processing unit and the display unit and/or the entire indirect vision system during operation of the vehicle, and/or errors occurred in vehicle components.

5. The maintenance system according to claim 2, wherein the environmental data comprises information about temperature, air humidity, air pressure, UV exposure, dust, fine dust (particular matter), and/or mechanical load, to which the at least one subcomponent, the at least one of the optical sensor unit, the processing unit and the display unit and/or the entire indirect vision system, is subjected.

6. The maintenance system according to claim 1, wherein the evaluation unit further comprises a calculation unit which subjects at least a part of the vehicle data and/or environmental data received from the receiving unit, the at least one vehicle sensor and/or the at least one additional sensor to a calculation function or calculation matrix and generates the maintenance signal based on the calculated value, wherein the calculation function or the calculation matrix comprises at least part of the received vehicle data and/or environmental data as a function parameter or matrix element.

7. The maintenance system according to claim 1, wherein a plurality of maintenance signals is used and calculated, and the resulting maintenance signal indicates how long the at least one sub-component, the at least one of the at least one optical sensor unit, the at least one processing unit and the at least one display unit, and/or the entire indirect vision system is still usable.

8. The maintenance system according to claim 1, wherein the evaluation unit comprises a counter and a comparison unit, wherein the data and/or calculated/processed data received by the receiving unit is compared with a threshold value and the counter increments when the threshold value is exceeded.

9. The maintenance system according to claim 8, wherein the evaluation unit generates the maintenance signal based on the value of the counter.

10. The maintenance system according to claim 9, further comprising an action recommendation unit which receives the maintenance signal from the evaluation unit, generates an action signal based on the value of the counter and transmits it to the at least one display unit, diagnostic device and/or to a cloud for output.

11. The maintenance system according to claim 1, wherein the maintenance signal generated by the evaluation unit is transmitted to the at least one display unit diagnostic device and/or cloud for output.

12. The maintenance system according to claim 1, further comprising a memory storing the data received from the receiving unit, the data calculated by the calculation unit, the maintenance signal, the action signal and/or the threshold value.

13. The maintenance system according to claim 1, wherein
the at least one subcomponent, the at least one of the at least one optical sensor unit, the at least one processing unit and the at least one display unit, and/or the entire indirect vision system comprises a memory in which the information contained in the maintenance signal is stored, which indicates how long and/or whether the subcomponent, the at least one of the at least one optical sensor unit, the at least one processing unit and the at least one display unit, and/or the entire indirect vision system is still usable.

14. The maintenance system according to claim 1, wherein the receiving unit and/or the evaluation unit are part of the indirect vision system.

15. A method for generating a maintenance signal for an indirect vision system of a vehicle, comprising at least one optical sensor unit, at least one processing unit and/or at least one display unit, comprising the steps of
receiving data; and
generating a maintenance signal based on the received data which signal indicates how long at least one subcomponent of the at least one optical sensor unit, the at least one processing unit and/or the at least one display unit, and/or the at least one of the at least one optical sensor unit, the at least one processing unit and the at least one display unit, and/or the entire indirect vision system is still usable.

16. The method according to claim 15, wherein
the received data comprises vehicle data which is detected by at least one vehicle sensor, and which is relevant for the lifetime of the vehicle, the at least one subcomponent, the at least one of the at least one optical sensor unit, the at least one processing unit and the at least one display unit, and/or the indirect vision system, and/or the received data comprises environmental data obtained from at least one additional sensor, which data is independent of the vehicle and depend on environmental factors.

17. The method according to claim 16, wherein
the vehicle data comprises information about kilometers driven by the vehicle, kilometers driven by the vehicle during operation of the at least one subcomponent, the at least one of the optical sensor unit, the processing unit and the display unit, and/or the entire indirect vision system, operating time of the vehicle, operating time of the at least one subcomponent, the at least one of the optical sensor unit, the processing unit and the display unit and/or the entire indirect vision system, during operation of the vehicle and/or errors occurred in vehicle components.

18. The method according to claim 16, wherein
the environmental data comprises information about temperature, air humidity, air pressure UV exposure, dust, particulate matter, and/or mechanical stress (load), to which the at least one subcomponent, at least one of the at least one optical sensor unit, the at least one processing unit and the at least one display unit, and/or the indirect vision system is exposed.

19. The method according to claim 15, further comprising
calculating a function value, wherein the calculation function comprises at least a part of the received vehicle data and/or the environmental data as parameters; and
generating the maintenance signal based on the function value.

20. The method according to claim 15, further comprising
combining a plurality of maintenance signals; and
using the resulting maintenance signal that indicates how long the at least one sub-component, at least one of the at least one optical sensor unit, the at least one processing unit and the at least one display unit, and/or the entire indirect vision system can still be used.

21. The method according to claim 19, further comprising
comparing the received data and/or the calculated data with a threshold value; and
incrementing a counter when the threshold value is exceeded.

22. The method according to claim 21, further comprising
generating the maintenance signal based on the value of the counter, and
outputting the maintenance signal to the at least one display unit, diagnostic device and/or cloud.

23. The method according to claim 21, further comprising
generating an action signal based on the value of the counter, and
outputting the action signal to the at least one display unit, diagnostic device and/or cloud.

24. The method according to claim 15, further comprising storing the received data, the calculated data, the threshold value and/or the maintenance signal in at least the subcomponent, at least one of the at least one optical sensor unit, the at least one processing unit and the at least one reproducing unit, and/or in the indirect vision system.
